(19) United States
(12) Patent Application Publication
(10) Pub. No.: US 2024/0068369 A1
(43) Pub. Date: Feb. 29, 2024

(54) FLUID TURBINE

(71) Applicant: XFlow Energy Company, Seattle, WA (US)

(72) Inventors: Ian D. Brownstein, Seattle, WA (US); Benjamin W. Strom, Seattle, WA (US)

(73) Assignee: XFlow Energy Company, Seattle, WA (US)

(21) Appl. No.: 18/500,953

(22) Filed: Nov. 2, 2023

Related U.S. Application Data
(63) Continuation of application No. 17/246,338, filed on Apr. 30, 2021.
(60) Provisional application No. 63/023,151, filed on May 11, 2020.

(51) Int. Cl. F01D 5/14; F03D 3/06

(52) U.S. Cl. CPC F01D 5/147; F03D 3/062; F03D 3/064; F05B 2240/30; F05D 2240/30

(57) ABSTRACT

A fluid turbine is described herein. The fluid turbine is subject to internal stresses, which can increase the frequency of maintenance or cost of construction, including fixing or replacing one or more components or increasing the amount of material used. One or more support arms of the fluid turbine can be provided in a given manner to generate a force during rotation that opposes one or more other forces, thereby reducing or eliminating the internal stresses exerted on the fluid turbine. For example, the one or more support arms can be provided in a given orientation or with given masses to generate the opposing force. In another example, the one or more support arms can be shaped or angled to generate an aerodynamic force.

### CROSS-REFERENCE TO RELATED APPLICATION

This application is a continuation application of U.S. application Ser. No. 17/246,338, which claims the benefit of pending U.S. Provisional Application 63/023,151, filed May 11, 2020, the contents of which are herein incorporated by reference in their entirety.

### BACKGROUND

Renewable energy is energy that is collected from renewable sources, including wind, solar, hydropower, geothermal, and biomass. In the United States, renewable energy is the fastest-growing energy source, increasing approximately 100 percent from 2000 to 2018. In 2018, renewable energy within the United States accounted for approximately 17.1 percent of electricity generation. Electricity generation is anticipated to increase to 24 percent by 2030 with most of the increase expected to come from wind and solar. Consumption of renewables within the United States over the next 30 years is projected to grow at an average annual rate of 1.8 percent. In 2018, in the United States, wind power accounted for approximately 6.6 percent of net electricity generation.

On a global scale, renewables accounted for approximately 26.2 percent of electricity generation in 2018. By 2040, that is projected to increase to 45 percent, with a majority of the increase coming from solar, wind, and hydropower. After hydropower, wind provided the second most power generation—producing more than 5 percent of global electricity in 2018 with 591 gigawatts (GWs) of global capacity.

As renewables, such as wind, increase in usage, operations and maintenance of the equipment generating the electricity from the renewables will increase. For example, operations and maintenance cost can range from $42,000 to $48,000/megawatt during the 10 years of a wind turbine's operation.

What is needed is a fluid turbine with a reduced cost of manufacture. What is needed is a fluid turbine with lower internal stresses, reducing the material requirements and mass for the purpose of reducing manufacturing costs.

### BRIEF DESCRIPTION OF THE DRAWINGS

FIGS. 1A-1B illustrates an example wind turbine.

FIG. 2 illustrates a top down view of the example wind turbine.

FIG. 3A illustrates a top down view of an example rotor.

FIG. 3B illustrates a top down view of an example rotor.

FIG. 3C illustrates a top down view of an example rotor.

FIG. 4A illustrates an example rotor.

FIG. 4B illustrates an example rotor.

FIG. 5 illustrates an example rotor.

FIG. 6 illustrates an example rotor.

FIG. 7 illustrates an example rotor.

FIG. 8 illustrates an example rotor.

FIG. 9A illustrates an example rotor.

FIG. 9B illustrates an example blade and example support arms of the example rotor of FIG. 9A.

### DETAILED DESCRIPTION

A fluid turbine can convert fluid energy into another form of energy, such as electricity, or can be used to generate work or force to be applied to another device or to provide an additional function, such as pumping water.

In one example, the fluid, such as air or water, turns a rotor, which is connected directly to a gearbox. The gearbox converts a lower speed rotation of the drive shaft into a higher speed rotation to drive the generator. The generator converts the kinetic energy of the rotation into electrical energy.

In another example, the fluid turns a rotor, which is connected to a permanent magnet generator to generate electricity. No gearbox is used. A drive shaft can be included, where it is desirous to do so.

In yet another example, the fluid turns a rotor, which spins a generator via a drive shaft, thereby creating electricity. More specifically, the kinetic energy of the moving air causes a rotor, having one or more blades, to rotate a drive shaft. The drive shaft is connected to a generator via a gearbox, where it is desirous to do so.

Forces acting on the fluid turbine, such as those due to a gravitational force, exert one or more stresses on each blade and their corresponding one or more support arms. In one example, these stresses can increase the frequency of maintenance, including fixing or replacing one or more components. In another example, the cost of the fluid turbine can be reduced by using less material, due, at least in part, to the reduced stresses as the net forces are reduced or eliminated.

To reduce the stresses, such as by offsetting the forces acting on the fluid turbine, one or more characteristics of the rotor can be provided to produce or generate a force on the one or more arms in a direction opposite another force, such as a gravitational force. The oppositely directed forces reduce or eliminate the internal stresses. In other words, a net force exerted on the blade or support arms by one or more external forces can be reduced or eliminated, such as by implementing or altering a support arm characteristic. The one or more support arms can generate one or more forces during rotor rotation to reduce or eliminate one or more other forces, such as generating an upward force to counter the downward force of gravity.

The characteristic can be angle of deployment, mass, airfoiling, the like, or combinations thereof. In one example, a support arm can be extended in a downward angle relative to a horizontal axis from the hub to the blade. In another example, such as when there are two or more support arms, the masses can be different such as the upper arm having a greater mass than the lower arm. In yet another example, the support arm can be shaped, tilted, or both to generate aerodynamic lift.

For ease of convenience, the example fluid turbine is discussed herein as a vertical axis wind turbine. However, the fluid turbine is not intended to be so limited. The fluid turbine can be driven by any fluid, including air (e.g., wind) or a liquid (e.g., water). The fluid turbine can also have any orientation or axis orientation, including vertical or horizontal such that the axis of rotation is perpendicular or parallel to incoming fluid flow (e.g., free-stream velocity vector). Most generally, a fluid turbine with its axis of rotation perpendicular to the incoming fluid flow is referred to as a cross flow fluid turbine and a fluid turbine with its axis of rotation parallel to the incoming fluid flow is referred to as an axial fluid turbine. The fluid turbine can be a cross flow or axial flow turbine.

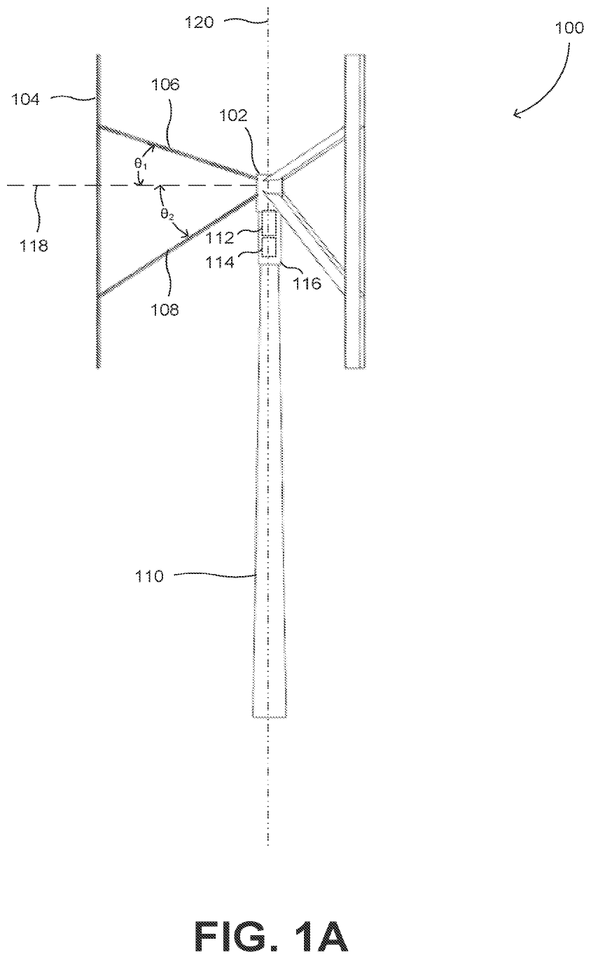

FIGS. 1A-1B show a vertical axis wind turbine (VAWT) 100. The VAWT 100 includes a rotor connected to a gearbox 112. The rotor includes blades 104 connected to a hub 102. Each blade 104 is connected to the hub 102 via a first support arm 106 and a second support arm 108. In other words, the rotor includes the blades 104, the hub 102, and each first and second support arms 106, 108. The hub 102 is adjoined to the gearbox 112

The rotor collects the energy present in the wind and transforms this energy into mechanical motion. The amount of energy the rotor can extract from the wind is proportional to the swept area of the rotor, which can include a rotor diameter R_{D}, a rotor height R_{H}, or both. For example, as the rotor diameter R_{D} increases, the amount of energy the rotor extracts from the wind increases. As another example, as the rotor height R_{H} increases, the amount of energy the rotor extracts from the wind increases. The blades 104 convert the kinetic energy of the wind into the rotation of the hub 102.

The first support arm 106 is at an upward angle (θ₁) relative to a horizontal axis 118. The second support arm 108 is at a downward angle (θ₂) relative to the horizontal axis 118. θ₂ is greater than θ₁. During rotation, the support arms 106, 108 are pushed toward the horizontal axis 118. θ₂ being greater than θ₁ generates an upward force on the rotor during rotation since the force (e.g., centripetal force) of the second support arm 108 is greater than the force (e.g., centripetal force) of the first support arm 106. In other words, the force to direct the first support arm 106 downward towards the horizontal axis 118 is less than the force to direct the second support arm 108 upward towards the horizontal axis 118, thereby resulting in a total upward force on the rotor. The total upward force, being opposite a gravitational force exerted on the support arms 106, 108 and the blade 104, reduces or eliminates the internal stresses of the VAWT 100.

The gearbox 112 converts a lower speed rotation of the rotor into a higher speed rotation to drive the generator 114. The types of gearboxes can include planetary, helical, parallel shaft, spur, worm, the like, or combinations or multiples thereof. The types of generators can include permanent magnet, induction, reluctance, the like, or combinations or multiples thereof. The generator 114 can also be classified as a motor, such that the motor is operated in reverse to function as a generator. The generator 114 converts the kinetic energy of the rotation into electrical energy.

The VAWT 100 can also include a housing 116. The housing 116 can cover, enclose, or protect one or more components of the VAWT 100, including the gearbox 114, the generator 116, or both.

The VAWT 100 can also include a tower 110 to support the weight of the blades 104, the generator 114, the gearbox 112, and any other component. The tower 110 can also resist the side-force of the wind.

The VAWT 100 and the components thereof can be composed of a metal (e.g., aluminum or steel), fiberglass, carbon fiber, a polymer, the like, or combinations or multiples thereof. The VAWT 100 and the components thereof can be formed by machining, welding, casting, extrusion, pultrusion, molding, 3-D printing, additive manufacturing, the like, or combinations or multiples thereof.

In one example, the VAWT can include a drive shaft connected to the hub 102 and the gearbox 112. In another example, the rotor is connected directly to the generator 114 such as a permanent magnet generator.

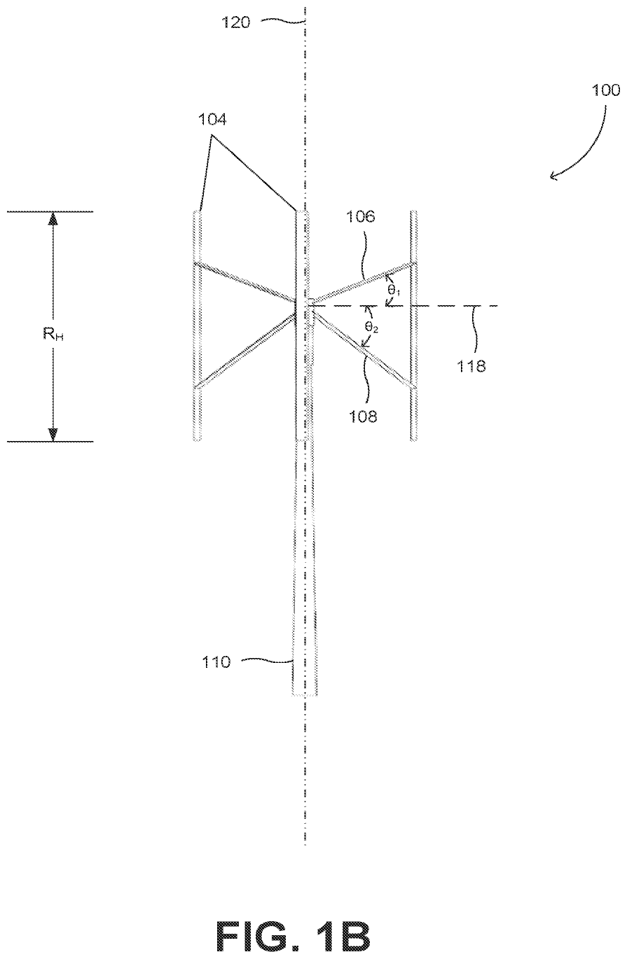

The first and second support arms 106, 108 can be any appropriate length. In one example, as shown in FIG. 2, the length of the second support arm 108 can be a ratio relative to the rotor diameter R_{D}. The length of the second support arm 108 can be greater than or equal to ½ (one-half) of the rotor diameter R_{D}, including, without limitation, lx the rotor diameter R_{D}, 1.5× the rotor diameter R_{D}, or the like. In another example, the length of the second support arm 108 can be a value. The length of the second support arm 108 can be, for example, less than or equal to 30 inches, or greater than 30 inches.

The first and second support arms 106, 108 can have any appropriate cross-sectional dimension.

The first and second support arms 106, 108 can have any appropriate cross-sectional shape, including, square, rectangle, circular, triangular, or the like.

In one example, the blades 104 can be composed of multiple pieces, such that the pieces are separable from each other.

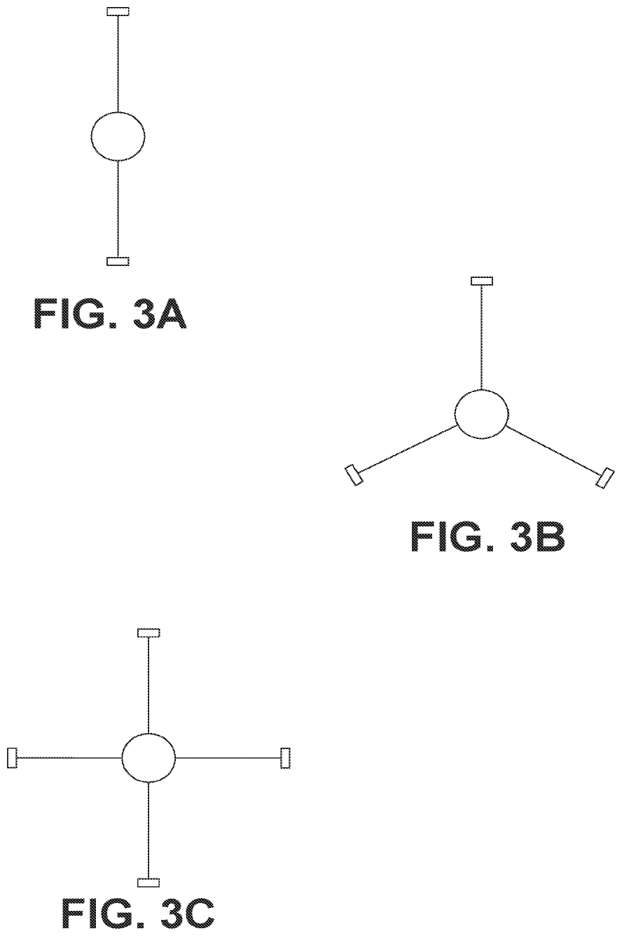

In one example, the blades 104 can be straight and parallel to a central axis 120, as shown in FIGS. 1A-1B. In another example, the blades 104 can be helical, as shown in FIG. 4A. The upper and lower ends of the blades 104 begin and end at different azimuthal angles while maintaining a substantially constant radial distance from a central axis 120. In yet another example, the blades 104 can be tilted, as shown in FIG. 4B, such that the blades 104 are not parallel the central axis 120 (i.e., tilted forward, backward, side-to-side, or combinations thereof).

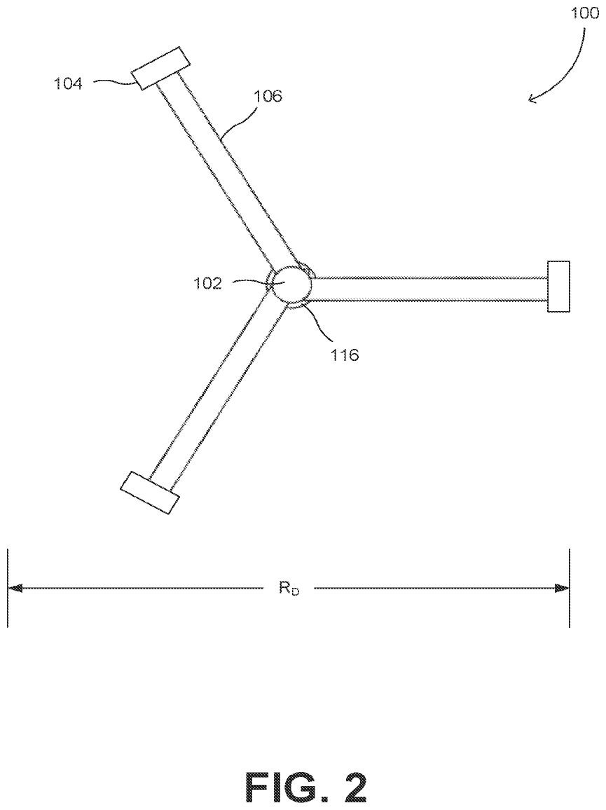

The rotor can include any number of blades, including 1 blade, 2 blades (FIG. 3A), 3 blades (FIG. 3B), 4 blades (FIG. 3C), or more. Furthermore, though 2 support arms are discussed, the rotor can include at least one support arms, including 1, 2, 3, 4, 5, 6, 7, 8, 9, 10, or more support arms. The one or more support arms generate one or more forces, such as an upward force, during rotor rotation to reduce or eliminate one or more other forces, such as a downward force. In one example, the rotor can include more than 2 support arms. For example, a third support arm can be horizontal. As another example, a third support arm can have a downward or upward angle. In another example, the rotor can include 1 support arm. For example, the 1 support arm can generate an upward force during rotor rotation.

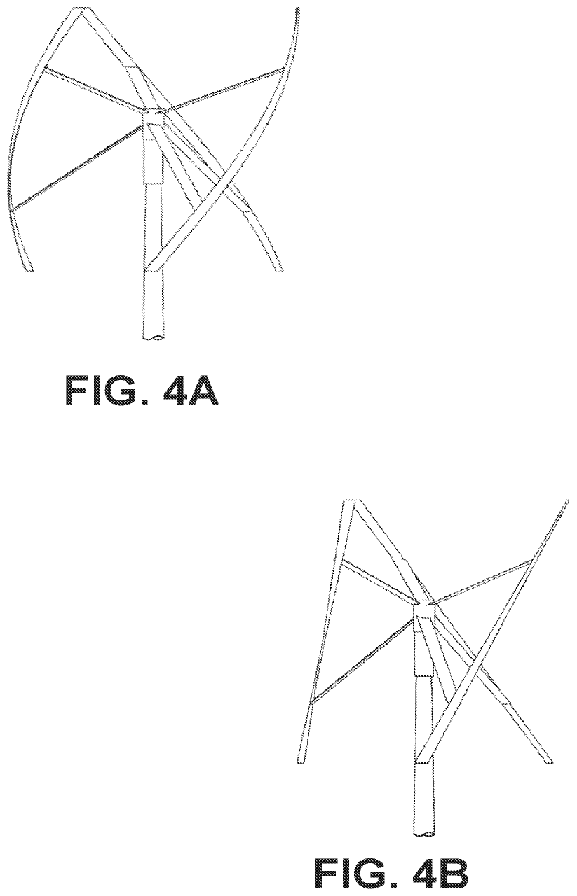

FIG. 5 shows a rotor 500 including the hub 102, the housing 116, a first support arm 502 and a second support arm 504. The first and second support arms 502, 504 are both at downward angles (θ₃, θ₄, respectively) relative to a first horizontal axis 506 and a second horizontal axis 508, respectively.

θ₃ can be greater than, equal to, or less than θ₄. During rotation, the downward angles cause the support arms 502, 504 to push toward the horizontal axes 506, 508, respectively, and generate upward forces on the rotor during rotation. In other words, the force to direct the first support arm 502 downward towards the first horizontal axis 506 plus the force to direct the second support arm 504 upward towards the horizontal axis 508 results in a total upward force. The total upward force, being opposite a gravitational force exerted on the support arms 502, 504 and a blade 510, reduces or eliminates the internal stresses.

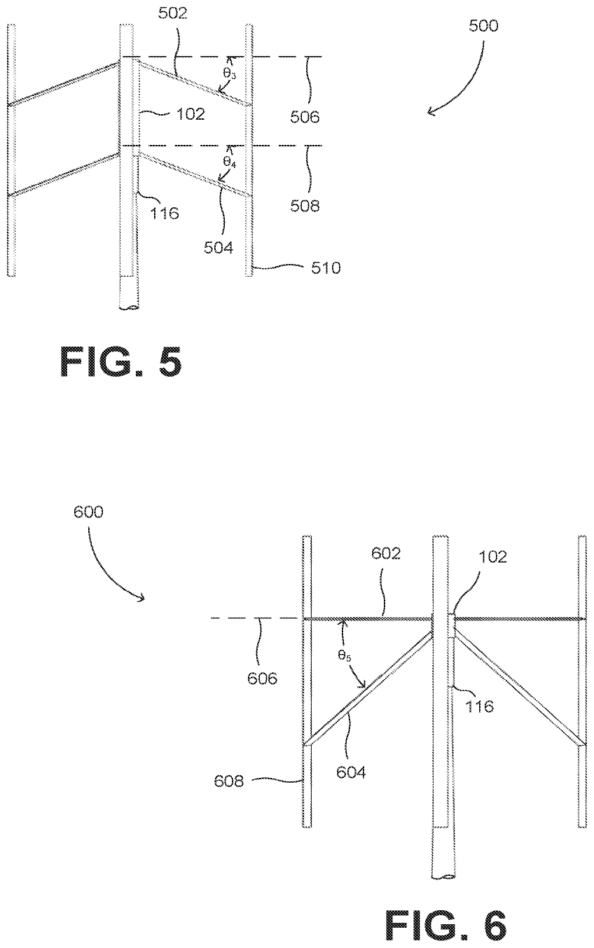

FIG. 6 shows a rotor 600 including, the hub 102, the housing 116, a first support arm 602 and a second support arm 604. The first support arm 602 is parallel to a horizontal axis 606. The second support arm 604 is at downward angle (θ₅) relative to horizontal axis 606. During rotation, the downward angle causes the second support arm 604 to push toward the horizontal axis 606 and generate an upward force during rotation. The first arm support arm 602, being parallel to the horizontal axis 606, does not generate an upward force. In other words, the force to direct the second support arm 604 upwards towards the horizontal axis 606 results in a total upward force. The upward force, being opposite a gravitational force exerted on the support arms 602, 604 and a blade 608, reduces or eliminates the internal stresses.

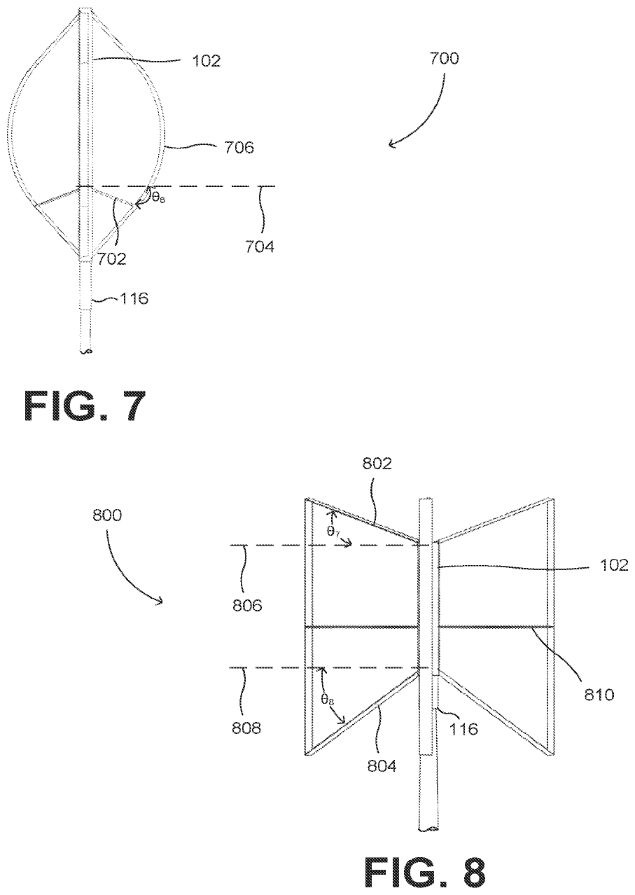

FIG. 7 shows a rotor 700 including the hub 102, the housing 116, a first support arm 702. The first support arm 702 is at downward angle (θ₆) relative to a horizontal axis 704. During rotation, the downward angle causes the first support arm 702 to push toward the horizontal axis 704 and generate an upward force during rotation. In other words, the force to direct the first arm support arm 702 upwards towards the horizontal axis 704 results in a total upward force. The upward force, being opposite a gravitational force exerted on the first support arm 702 and a blade 706 (e.g., curved blade), reduces or eliminates the internal stresses.

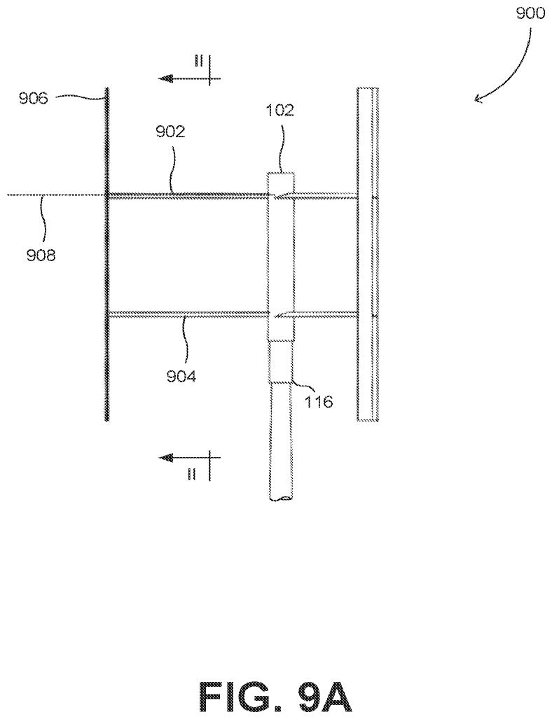

FIG. 8 shows a rotor 800 including the hub 102, the housing 116, a first support arm 802, and a second support arm 804. The first support arm 802 is at an upward angle (θ₇) relative to a horizontal axis 806. The second support arm 804 is at a downward angle (θ₈) relative to a horizontal axis 808.

In one example, θ₈ is equal to θ₇. During rotation, the support arms 802, 804 are pushed toward the horizontal axis 808. The equal angles does not generate a total upward force. However, the second support arm 804 has a mass greater than a mass of the first support arm 802. The difference in mass between the first and second support arms 802, 804 generates a total upward force. The total upward force, being opposite a gravitational force exerted on the support arms 802, 804 and the blade 104, reduces or eliminates the internal stresses.

In other words, when the angles from the horizontal axis are equal, an upward force can be generated by having a mass of a downward support arm be greater than a mass of an upward support arm.

In another example, θ₈ less than θ₇. During rotation, the support arms 802, 804 are pushed toward the horizontal axes 806, 808. The first support arm 802 creates a downward force. However, the second support arm 804 has a mass greater than a mass of the first support arm 802. The difference in mass between the first and second support arms 802, 804 generates a total upward force. The total upward force, being opposite a gravitational force exerted on the support arms 802, 804 and the blade 104, reduces or eliminates the internal stresses.

In other words, despite the angle of the first support arm 802 being greater than the angle of the second support arm 804, a upward force can be generated by having a mass of a downward support arm be greater than a mass of an upward support arm.

In another example, θ₈ greater than θ₇. During rotation, the support arms 802, 804 are pushed toward the horizontal axes 806, 808. The second support arm 804 creates a upward force. Additionally, the second support arm 804 has a mass greater than a mass of the first support arm 802. The difference in mass between the first and second support arms 802, 804 and angles from the horizontal axes 806, 808 generate a total upward force. The total upward force, being opposite a gravitational force exerted on the support arms 802, 804 and the blade 104, reduces or eliminates the internal stresses.

In other words, an upward force can be cumulative and generated by having a mass and angle of a downward support arm be greater than a mass and angle of an upward support arm.

The rotor can also include at least a third support arm 810. Accordingly, the rotor can include 3 or more support arms.

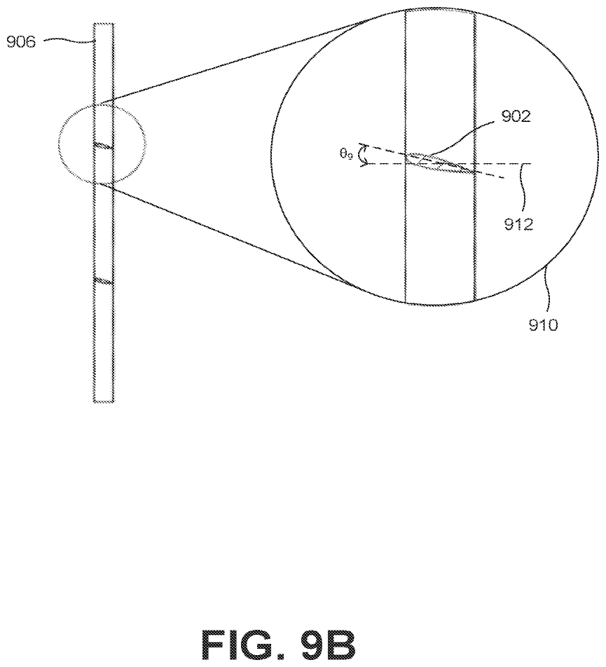

FIG. 9A shows a rotor including the hub 102, the housing 116, blades 906, a first support arm 902, and a second support arm 904. FIG. 9B shows a cross-section view of the first and second support arms 902, 904 taken along line II-II and a magnified view 910 of cross-section of the first support arm 902. The first arm 902, the second support arm 904, or both can be cross-sectionally shaped, tilted, or both to generate, provide, or increase aerodynamic lift. Aerodynamic lift is a force generated when an object moves through a fluid, such as air. The aerodynamic lift reduces or eliminates one or more other forces, such as a downward force.

The first arm 902, the second support arm 904, or both can have a cross-section shape of an airfoil.

The first arm 902, the second support arm 904, or both be tilted about a first horizontal axis 908 to have an angle (θ₉) relative to a second horizontal axis 912. The first and second horizontal axes 908, 912 are perpendicular to each other.

In one example, as shown in FIG. 9B, the angle θ₉ is positive relative to the second horizontal axis 912. In another example, the angle θ₉ can be parallel to or negative with respect to the second horizontal axis 912.

Though certain elements, aspects, components or the like are described in relation to one embodiment or example of a fluid turbine, those elements, aspects, components or the like can be including with any other fluid turbine, such as when it desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents:

What is claimed is:

1. A fluid turbine, comprising:
a rotor comprising a hub and a rotor segment, the rotor segment comprising:
a blade,
a first support arm configured to adjoin the blade to the hub,
and a second support arm configured to adjoin the blade to the hub, wherein a combined center of mass of the blade, the first support arm, and the second support arm is positioned vertically below a location defined as a vertical midpoint between the intersection of the first support arm and the hub and the intersection of the second support arm and the hub, such that rotation of the rotor causes a force to be generated in a direction opposite a gravitational force on the rotor segment.

2. The fluid turbine of claim 1, wherein the rotor segment further comprises a third support arm positioned vertically between the first and second support arms, wherein the center of mass of the rotor segment includes the third support arm.

3. The fluid turbine of claim 2, wherein the rotor segment further comprises a plurality of additional support arms, including the third support arm, positioned vertically between the first and second support arms, wherein the center of mass of the rotor segment includes the plurality of additional support arms.

4. The fluid turbine of claim 1, wherein the first and second support arms have a cross section in the shape of an airfoil.

5. The fluid turbine of claim 1, wherein the first and second support arms have a length greater than or equal to one-half of a rotor diameter.

6. The fluid turbine of claim 1, wherein the first and second support arms have a cross-sectional shape to generate or increase aerodynamic lift when the rotor rotates.

7. The fluid turbine of claim 6, wherein the cross-sectional shape is an airfoil.

8. The fluid turbine of claim 1, wherein the first and second support arms are tilted about a first axis to have an angle relative to a second axis, wherein the first and second axes are horizontal and are perpendicular to each other.

9. The fluid turbine of claim 8, wherein the first and second support arms are tilted at the angle to generate or increase aerodynamic lift when the rotor rotates.

10. The fluid turbine of claim 1, wherein the rotor further comprises a plurality of additional rotor segments.

11. The fluid turbine of claim 10, wherein each of the plurality of additional rotor segments is configured to adjoin to the hub.

12. The fluid turbine of claim 11, wherein each of the plurality of additional rotor segments comprises a respective blade and respective first and second support arms configured to adjoin the respective blade to the hub.

13. The fluid turbine of claim 12, wherein, for each of the plurality of additional rotor segments, the respective first support arm is configured to extend from the hub at the upward angle from a horizontal axis and the respective second support arm is configured to extend from the hub at the downward angle from the horizontal axis.

14. The fluid turbine of claim 13, wherein, for each of the plurality of additional rotor segments, the respective first support arm is configured to extend from the hub at an upward angle from a horizontal axis and the respective second support arm is configured to extend from the hub at a downward angle from the horizontal axis, wherein the upward angle between the respective first arm and the horizontal plane is less than the downward angle between the respective second arm and the horizontal plane.

15. A fluid turbine of claim 1, wherein the combined center of mass of the rotor segment is positioned vertically below the vertical midpoint between the intersection of the first support arm and the hub and the intersection of the second support arm and the hub due to the downward deflection of the rotor segment at least partially based on the influence of gravity.
